(19) United States
(12) Patent Application Publication
(10) Pub. No.: US 2001/0003859 A1
(43) Pub. Date: Jun. 21, 2001

(54) PROCESS FOR FORMING A PUNCH RIVET CONNECTION AND A JOINING DEVICE FOR PUNCH RIVETS

(76) Inventors: DIETER MAUER, LOLLAR (DE); HERMANN ROSER, BIEBERTAL (DE)

Correspondence Address: EDWARD D MURPHY, PATENT DEPARTMENT TW 199, THE BLACK AND DECKER CORPORATION, 701 EAST JOPPA ROAD, TOWSON, MD, 21286

(21) Appl. No.: 09/119,255

(22) Filed: Jul. 20, 1998

(30) Foreign Application Priority Data
Jul. 21, 1997 (DE) 197 31 222.5

(51) Int. Cl. B23Q 17/00

(52) U.S. Cl. 29/407.04

(57) ABSTRACT

The invention relates to a process for forming a punch rivet connection and to a joining device, a plunger (4) and optionally a clamp (5) being driven via a transmission unit (2). The transmission unit (2) converts a rotational movement of an electric motor drive unit (1) into a translation movement of the plunger (4) or of the clamp (5).

The invention relates to a process for forming a punch rivet connection and to a joining device for punch rivets.

To form a punch rivet connection with which at least two parts to be joined can be connected to one another by a rivet, it is not necessary for the parts to be joined to be pre-punched. It is known that a punch rivet connection can be made using a solid rivet or hollow rivet. Punch rivets may also be described as self-piercing rivets.

A punch rivet connection is formed with a solid rivet by placing the parts to be joined on a die. A clamp is brought into contact with the parts to be joined above the die. The parts to be joined are clamped between the clamp and the die. The clamp is hollow in design. The rivet is arranged in it. A plunger acts on the rivet so that the plunger punches the rivet through the parts to be joined. The rivet punches a hole in the parts to be joined so the pre-punching required in conventional riveting processes is unnecessary. Once the rivet has penetrated the parts to be joined, the clamp presses the parts to be joined against the die which comprises a ferrule. The force of the clamp and the geometry of the die result in plastic deformation of the die-side part to be joined which flows partially into an annular groove in the punch rivet. The solid rivet is not deformed. The parts to be joined are reached by the geometry of the rivet head and by the die-side connection of the part to be joined to the rivet in the annular groove.

Hydraulically operated joining devices are used to form such a punch rivet connection. The plunger is actuated by a hydraulic cylinder unit. The cost of producing such joining devices is relatively high. In particular, process control for achieving high-quality punch rivet connections gives rise to problems. In particular, hydraulically operated joining devices are subject to variations in the force exerted by the plunger owing to changes of viscosity. The changes in the viscosity of the hydraulic medium are substantially dependent on temperature. A further drawback of hydraulically operated joining devices is that the hydraulic medium, which may be oil, has a hydroscopic effect so it is necessary to exchange the hydraulic fluid at predetermined time intervals.

When forming a punch connection with a hollow rivet—the same applies to a semi-hollow rivet—the hollow rivet penetrates the plunger-side part to be joined and penetrates partially into the die-side part to be joined. The die is so designed that the die-side part to be joined as well as the rivet are deformed to a closing head. An example of a design of a joining device for forming a punch rivet connection with a hollow rivet is known from DE 44 19 065 A1. Hydraulically operating joining devices are also used for producing a punch rivet connection with a hollow rivet.

The object of the present invention is to provide a process for forming a punch rivet connection by means of which the production costs for carrying out the process can be reduced. A further object of the invention is to monitor the formation of a punch rivet connection to improve quality assurance. A punch rivet joining device which is constructionally simple in design is also to be provided.

With the process according to the invention for forming a punch rivet connection, it is proposed that a plunger and optionally a clamp be driven via a transmission unit which converts a rotational movement of a drive unit into a translation movement of the plunger or of the clamp. The relatively high production costs incurred with known processes when the plunger and optionally a clamp is or are hydraulically operated are avoided when carrying out the process. A further advantage of the process is that relatively good control of the process can be achieved by converting the rotational movement of a drive unit into a translation movement of the plunger, as an electric motor can be used as drive unit. Different plunger speeds can also be achieved with the process control according to the invention. A further advantage of the process is that process control is independent of external influences. For example, whereas the ambient temperature is involved in hydraulic actuation of the plunger as it affects the hydraulic medium, this influence is absent from the process according to the invention.

According to a further advantageous embodiment of the process, it is proposed that the speed of the drive unit be variable. Owing to this feature, the speed with which the plunger or the clamp acts on the parts to be joined or the rivet can be varied. The speed of the drive unit can be adjusted as a function of the properties of the rivet and/or the properties of the parts to be joined. The advantage of the adjustable speed of the drive unit also resides in the fact that, for example, the plunger and optionally the clamp is initially moved at high speed to rest on the parts to be joined and the plunger and optionally the clamp is then moved at a lower speed. This has the advantage of allowing relatively fast positioning of the plunger and the clamp. This also affects the cycle times of a joining device.

According to a further advantageous idea, it is proposed that the plunger and optionally the clamp be movable from a predeterminable rest position. The rest position of the plunger and optionally of the clamp is selected as a function of the design of the parts to be joined. If the parts to be joined are, for example, smooth metal plates, the distance between a riveting unit which comprises the plunger and the clamp and a die can be slightly greater than the thickness of the superimposed parts to be joined. If a part to be joined has a ridge, as viewed in the feed direction of the part to be joined, the rest position of the riveting unit is selected such that the ridge can be guided between the riveting unit and the die. Therefore, it is not necessary for the riveting unit always to be moved into its maximum possible end position which is defined by maximum spacing between the riveting unit and a die.

According to a further advantageous embodiment of the process, it is proposed that the process data be determined during a punch riveting procedure.

In particular, the travel of the plunger and optionally of the clamp is determined during a punch riveting procedure. The travel of the plunger and optionally of the clamp is determined particularly easily as the stroke of the plunger or clamp can be determined from the number of rotations of the drive unit on the basis of the known transmission ratios from the rotational movement of the drive unit into a translation movement of the plunger or the clamp. For this purpose, the drive unit can be provided with known aids, for example an incremental disc. It is also possible to use a stepping motor as drive unit.

The force of the plunger and optionally of the clamp on the parts to be joined is preferably determined during a punch riveting procedure. A quality statement about the punch rivet connection can be derived from the variation of the force during the joining procedure, as described hereinafter.

According to a further advantageous idea, it is proposed that the power consumption of the drive unit be determined during a punch riveting procedure. The power consumption of the drive unit is substantially proportional to the force of the plunger and optionally of the clamp on the parts to be joined, so the force can be determined directly. Additional gauges are not necessarily required to determine the force. The power consumption can be determined using simple components.

In addition to or as an alternative to the determination of the power consumption or of the force of the plunger, it is proposed that the torque of the drive unit and/or of the transmission unit be determined during a punch riveting procedure. The torque of the drive unit and/or of the transmission unit is also proportional to the force of the plunger and optionally of the clamp on the parts to be joined. A quality statement about the punch riveting procedure or about the punch rivet connection can also be obtained from the torque measurement.

According to a further advantageous embodiment of the process, it is proposed that a force or a characteristic, corresponding to the force, of the plunger and optionally of the clamp be measured during a joining procedure as a function of the displacement of the plunger or of the plunger and the clamp. This produces a measured level. This is compared with a desired level. If comparison shows that the measured level deviates from the desired level by a predetermined limit value in at least one predetermined range, a signal is triggered. This process control has the advantage, in particular, that it permits qualitative monitoring of the formation of a punch connection.

According to a further advantageous embodiment of the process it is proposed that the measured level be compared with the desired level at least in a region in which clinching is substantially completed by the force of the plunger on a rivet which has come to rest on the parts to be joined and a rivet has penetrated into the plunger-side part to be joined. A statement as to whether a rivet has been supplied and the rivet has also been correctly supplied can be obtained by comparing the actual force/displacement trend with the desired level. The term ‘correctly supplied’ means a supply where the rivet rests in the correct position on the part to be joined. It can also be determined from the result of this comparison whether, for example, an automatic supply of rivets is being provided correctly.

According to a further preferred embodiment of the process, the measured level is compared with the desired level at least in a region in which the parts to be joined have been substantially punched by the force of the plunger on a rivet, in particular a solid rivet, and the clamp exerts a force on the plunger-side part to be joined. This has the advantage that it is possible to check whether the rivet actually penetrated the parts to be joined.

According to a further advantageous embodiment of the process, it is proposed that the measured level be compared with the desired level at least in a region in which a rivet, in particular a hollow rivet, substantially penetrated the plunger-side part to be joined owing to the force of the plunger and a closing head was formed on the rivet. It is thus also possible to check whether the parts to be joined also have a predetermined thickness.

According to a further idea, a comparison between the measured level and the desired level is proposed at least in a region in which a closing head is substantially formed on the rivet, in particular a hollow rivet, and clinching of the rivet takes place. It is thus possible to check whether the rivet ends flush with the surface of the plunger-side part to be joined.

It is also proposed that a force of the plunger or of the plunger and the clamp on the parts to be joined, or a characteristic corresponding to the force, be calculated from the power consumption. The change of the force as a function of the displacement of the plunger or of the plunger and the clamp can be allocated to specific parameters such as the thickness of the parts to be joined, the material of the parts to be joined, or the form and material of the punch rivet. Such information can be used for controlling a joining device if similar parts to be joined are to be connected to one another by comparable punch rivets. This has the advantage that the expenditure for determining the most desirable process parameters for forming a punch rivet can be reduced.

According to a further idea according to the invention, a joining device for punch rivets with a die, a clamp, a plunger, a drive unit connected to the plunger, a control unit for controlling at least the drive unit and a monitoring unit is proposed in which the drive unit has electric motor action. The electric motor drive unit is connected via a transmission unit to the plunger or to the plunger and the clamp. As a result, the rotational movement of the electric motor drive unit is converted via the transmission unit into a translational or linear movement of the plunger or of the plunger and the clamp. This design of the joining device also prevents intermittent stressing of the joining device of the type which occurs with known hydraulically operated joining devices. A further advantage of the device according to the invention is that the joining device can be used both movably and stationarily. With stationary use of the joining device, only one power connection is required for the electric motor drive unit. The joining device according to the invention can be produced economically.

The joining device is preferably so designed that the transmission unit has at least one gear. The gear is preferably a reduction gear. This has the advantage that a drive unit with a relatively low torque can be used. The relatively low torque of the drive unit is converted into a correspondingly higher torque or force on the plunger by the reduction gear as a function of the reduction ratio. The gear is preferably designed such that it has at least one predetermined reduction ratio.

According to a further advantageous idea, it is proposed that the plunger or the plunger and the clamp be connected to the transmission unit via a spindle drive. To avoid high frictional losses, it is proposed that the spindle drive be a circulating ball spindle drive.

The monitoring unit of the joining device according to the invention preferably has at least one sensor which serves to detect process data. It is proposed, in particular, that at least one sensor be a displacement transducer which indirectly or directly picks up the displacement of the plunger and optionally of the clamp during a joining procedure.

According to a further advantageous embodiment of the joining device, it is proposed that at least one sensor be a force transducer which indirectly or directly picks up the force of the plunger and optionally of the clamp during the joining procedure. It is proposed in particular that the force transducer have at least one piezoeletric element. Alternatively, the force transducer can be a load cell.

The force transducer is preferably arranged between the plunger and the transmission unit or between the clamp and the transmission unit. The transmission unit preferably rests on a framework. The force transducer is arranged between the transmission unit and the framework.

According to a further preferred embodiment of the joining device, it is proposed that at least one sensor measure the power consumption of the drive unit during a joining procedure.

Additionally or alternatively it is proposed that at least one sensor pick up the torque of the drive unit and/or of the transmission unit during a joining procedure.

Further details and advantages of the process according to the invention and of the joining device are described with reference to a preferred embodiment of a joining device illustrated in the drawings.

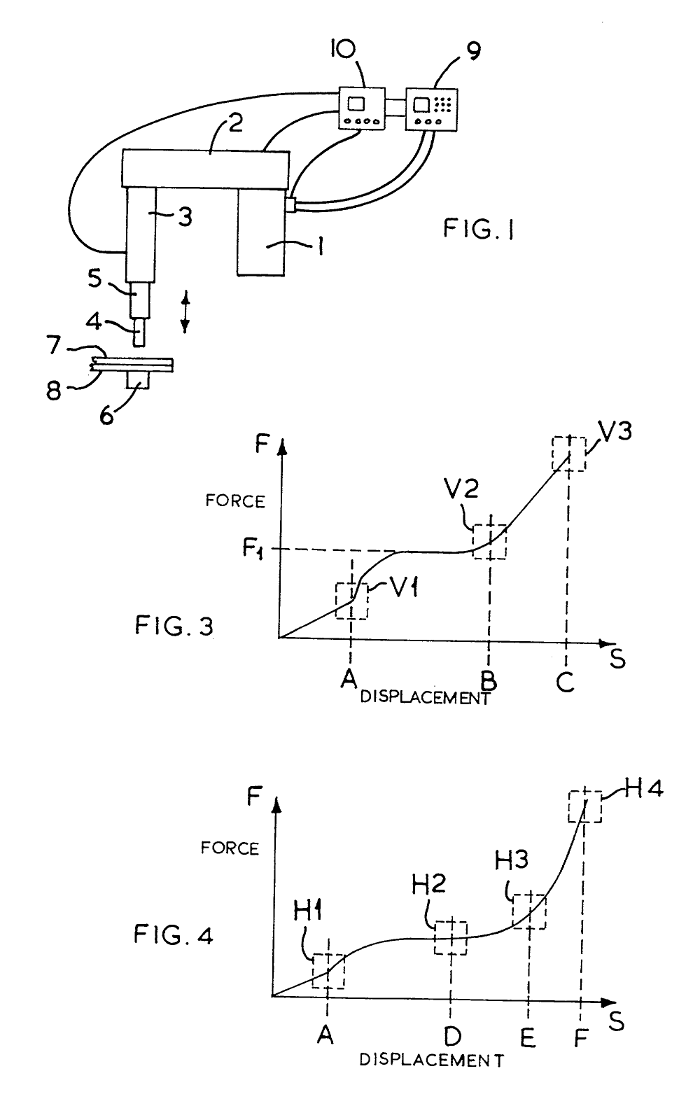

FIG. 1 is a schematic view of a joining device.

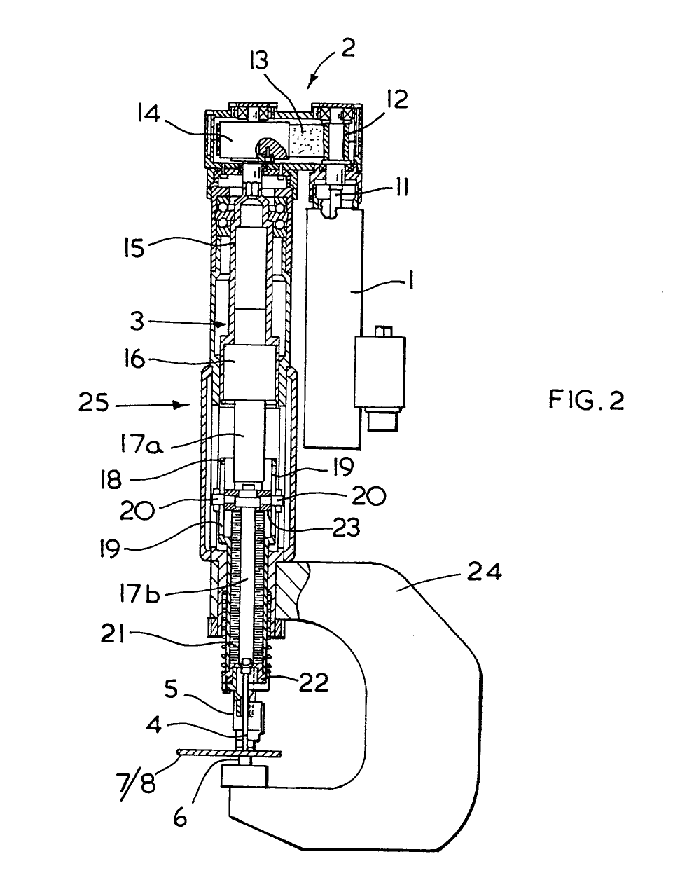

FIG. 2 is a section through a joining device.

FIG. 3 is a force/displacement graph of a punch riveting procedure with a solid rivet.

FIG. 4 is a force/displacement graph of a punch riveting procedure with a hollow rivet.

FIG. 1 is a schematic view of the design of a joining device for punch rivets. The joining device has an electric motor driven drive unit 1. The drive unit 1 is connected to a transmission unit 2. A drive shaft of the drive unit 1 can be coupled to the transmission unit 2. The coupling can preferably be releasable in design so different transmission units 2 can be used. The transmission unit 2 preferably has at least one gear. This is, in particular, a reduction gear. A gear which has at least one predetermined reduction ratio is preferred.

The transmission unit is connected to a plunger 4 or to the plunger 4 and the clamp 5. Whether merely the plunger 4 or also the clamp 5 is connected to the transmission unit 2 depends on whether the joining device is used to form a punch rivet connection with a solid rivet or a hollow rivet. If the joining device is used for forming a punch rivet connection by means of a solid rivet, the clamp 5 is also coupled to the transmission unit 2.

The plunger 4 or the plunger 4 and the clamp 5 are connected to the transmission unit 2 via a spindle drive 3. The spindle drive 3 can also be part of the transmission unit 2 so they form a constructional unit. The spindle drive 3 is preferably a circulating ball spindle drive.

The plunger 4 and the clamp 5 are movable in the direction of the arrow shown in FIG. 1. A die 6 is arranged beneath the plunger 4. Two parts to be joined 7, 8 are arranged schematically on the die 6.

The joining device also comprises a control unit 9 for controlling the drive unit 1. A monitoring unit 10 which comprises at least one sensor for detecting process data is connected to the control unit 9. A connection between the monitoring unit and the drive unit 1, the transmission unit 2 and the spindle drive 3 is shown schematically in FIG. 1. The drive unit 1, the monitoring unit 2 and the spindle drive 3 can have corresponding sensors for picking up specific characteristics, the output signals of which are processed in the monitoring unit 10. The monitoring unit 10 can be part of the control unit 9, the monitoring unit 10 emitting input signals as open and closed loop control variables to the control unit 9. The sensors can be displacement and force transducers which determine the displacement of the plunger 4 and the force of the plunger 4 on the parts to be joined 7, 8. A sensor which measures the power consumption of the electric motor action drive unit 1 can also be provided.

A punch rivet is arranged within the clamp to form a punch rivet connection between the parts to be joined 7, 8. The plunger 4 is displaceable relative to the clamp 5. The plunger 4 exerts a force on a punch rivet by means of which the punch rivet connection is obtained. The drive unit 1 is set into operation for this purpose. The rotational movement of the drive unit 1 is converted via a transmission unit 2 and, in the embodiment illustrated, the spindle drive 3 into a translation movement of the plunger 4 and the clamp 5.

FIG. 2 is a partial section through a joining device. The joining device has an electric motor operated drive unit 1. The drive unit 1 is connected to the transmission unit 2. The transmission unit 2 is arranged in an upper end region of a housing 25. The housing 25 is connected to a framework 24.

The drive shaft 11 of the drive unit 1 is connected to a belt wheel 12 of the transmission unit 2. The belt wheel 12 drives a belt wheel 14 via an endless belt 13 which may be a flexible toothed belt. The diameter of the belt wheel 12 is substantially smaller than the diameter of the belt wheel 14, allowing a reduction in the speed of drive shaft 11. The belt wheel 14 is rotatably connected to a drive bush 15. A gear with gear wheels can also be used instead of a transmission unit 2 with belt drive. Other alternatives are also possible. A rod 17a is transversely displaceable within the drive bush 15 which is appropriately mounted. The translation movement of the rod 17a is achieved via a spindle drive 3 having a spindle nut 16 which cooperates with the rod 17a. At the end region of the rod 17a remote from the transmission unit 2 there is formed a guide member 18 into which the rod 17a can be introduced. A rod 17b adjoins the rod 17a. An insert 23 is provided in the transition region between the rod 17a and the rod 17b. The insert 23 has pins 20 which project substantially perpendicularly to the axial direction of the rod 17a or 17b and engage in slots 19 in the guide member 18. This ensures that the rod 17a and 17b does not rotate. The rod 17b is connected to a plunger 4. The plunger 4 is releasable arranged on the rod 17b so it can be formed according to the rivets used. A stop member 22 is provided at the front end region of the rod 17b. Spring elements 21 are arranged between the stop member 22 and the insert 23. The spring elements 21 are spring washers. The spring elements 21 are arranged in a tubular portion of the guide member 18. The guide member 18 is arranged so as to slide in the housing 25. FIG. 2 shows the joining device in a position in which the plunger 4 and the clamp 5 rest on the parts to be joined 7, 8, the parts to be joined 7, 8 resting on the die 6.

In a punch rivet connection formed by a grooved solid rivet, the rivet is pressed through the parts to be joined 7, 8 by the plunger 4 once the parts to be joined 7, 8 have been fixed between the die 6 and the holding down device 5. The rivet punches a hole in the parts to be joined 7, 8 during this procedure.

The clamp 5 and the plunger 4 effect clinching which extends to point A of the curve in the force/displacement graph shown in FIG. 3. The rivet then punches a hole in the parts 7, 8 to be joined, this procedure taking place in the portion A-B. After punching has taken place, the clamp presses against the parts to be joined 7, 8. The clamp presses against the die such that the die-side part to be joined 8 flows into the groove of the rivet owing to a corresponding design of the die 6. This portion of the process lies between points B-C.

Regions in which the measured level of the force or a characteristic corresponding to the force as a function of the displacement can be compared with a desired level are designated by V1, V2 and V3 in FIG. 3. The regions V1, V2 and V3 are significant for the quality of the punch rivet connection. However, the entire measured level curve can also be compared with the desired level instead of selected regions V1, V2 or V3. A statement as to whether, for example, a solid rivet is arranged on the plunger-side part to be joined 7 with the correct orientation can be obtained by comparison in the region V1. A statement about the clinch behaviour of the parts to be joined can also be derived. If the clinch behaviour differs, it can be concluded that, for example, the plunger-side part to be joined consists of an incorrect material.

A statement as to whether, for example, complete punching of the parts to be joined 7, 8 has occurred can be obtained by comparison in region V2.

Comparison between the measured level and the desired level in region V3 provides a statement as to whether the material of the die-side part to be joined 8 has flown into an annular groove in a rivet, not shown.

The variation of the force as a function of the displacement can be determined by the process according to the invention from the power consumption of the electric motor drive 1.

FIG. 4 is a schematic view of a force/displacement graph of the type produced during a punch riveting procedure using a hollow rivet. The force/displacement graph shows that essentially four process portions can be detected in the punch rivet procedure using a hollow rivet. A first process portion which essentially corresponds to a clinching procedure can be seen up to point A. A second process portion which essentially corresponds to the cutting procedure can be seen between points A and D. During the cutting process, the plunger 4 and therefore also a rivet covers a relatively great displacement s, the force exerted by the plunger 4 on the rivet being relatively constant.

Once the rivet has cut through the plunger-side part to be joined 7, the rivet is spread in the die 6 as the force of the plunger 4 increases. This portion of the process is located between points D-E of the force/displacement graph according to FIG. 4. The die-side part to be joined 8 is deformed by the die 6 during this procedure.

If the force exerted on the rivet by the plunger 4 is sustained, the rivet is compressed. The compression process is shown in portion E-F in FIG. 4. If the head of the punch rivet lies in the plane of the plunger-side part to be joined 7, the punch rivet connection is produced.

The force/displacement curve can be determined from the process data. With a known force/displacement curve which serves as a reference, the quality of a punch connection can be determined by means of the measured level of the force as a function of the displacement.

FIG. 4 shows regions H1-H4 in which the measured level of the force as a function of the displacement is checked with a desired level. The regions H1-H4 are selected at the significant transition points of the process steps, as described hereinbefore. A quality statement about the punch rivet connection can therefore be obtained. The entire measured level can also be checked with a desired level rather than individual regions H1-H4, the desired level forming a band within whose limits the measured level is to lie.

What is claimed is:

1. A process for forming a punch rivet connection comprising the steps of
providing a punch rivet;
providing a workpiece to be engaged by the rivet;
providing a plunger (4) for driving the rivet into the workpiece;
providing a drive system for the plunger including a source (1) of rotary motion and a transmission (2) for converting rotary motion into linear motion; and
operating the drive system to drive the rivet into the workpiece.

2. A process according to claim 1 and further including the steps of
providing a clamp device (5) for engaging the workpiece;
connecting the drive system to the clamp device; and
operating the drive system to engage the clamp device with the workpiece.

3. A process according to claim 1 wherein the source of rotary motion comprises an electric motor.

4. A process according to claim 3, in which the speed of the electric motor (1) is variable.

5. A process according to claim 1, in which the plunger is (4) initially moved at high speed to a point of initial contact with the workpiece and thereafter is moved at a lower speed.

6. A process according to claim 2, during which the plunger (4) and the clamp device (5) are moved from a predeterminable rest position.

7. A process according to claim 1, in which the displacement of the plunger (4) is measured during the punch riveting procedure.

8. A process according to claim 1, in which the force exerted by the plunger (4) on the workpiece is measured during the punch riveting process.

9. A process according to claim 2 wherein the forces exerted by the plunger and the clamp device are each measured during the riveting process.

10. A process according to claim 1, in which the power consumption of the drive unit (1) is measured during the punch riveting process.

11. A process according to claim 1, in which the torque of the drive unit (1) is measured during the punch riveting procedure.

12. A process according to one of claims 7 to 11, in which a characteristic corresponding to the force of the plunger (4) as a function of the displacement of the plunger (4) is measured during a joining procedure and compared with a desired level and a signal is triggered when the measured level differs from the desired level by a predetermined limit value in at least one predetermined region.

13. A process according to claim 12, in which a comparison between the measured level and the desired level takes place at least in a region (V1, H1) in which clinching effected on the workpiece by the force of the plunger (4) acting on a rivet essentially takes place and a rivet penetrates into a plunger-side part (7) of the workpiece.

14. A process according to claim 12, in which the measured level is compared with the desired level at least in a region (V2) in which punching of the parts to be joined (7, 8) is essentially effected by the force of the plunger (4) acting on a solid rivet, and the clamp (5) exerts a force on the plunger-side part (7) of the workpiece.

15. A process according to claim 12, in which the measured level is compared with the desired level at least in a region (H2) in which a hollow rivet, penetrates the plunger-side part (7) of the workpiece owing to the force of the plunger (4) and a closing head is formed on the rivet.

16. A process according to claim 12, in which the measured level is compared with the desired level at least in a region (H3) in which a closing head is essentially formed on a hollow rivet, and the rivet is compressed.

17. A joining device for punch rivets comprising a die (6), a clamp (5), a plunger (4), a drive unit (1) connected to the plunger (4), a control unit (9) for controlling at least the drive unit (1) and a monitoring unit (10) connected to the control unit (9), said drive unit comprising an electric motor (1) which is connected via a transmission unit (2) to the plunger (4) and the clamp (5).

18. A joining device according to claim 17, characterised in that the transmission unit (2) has at least one gear.

19. A joining device according to claim 18, characterised in that the gear is a reduction gear.

20. A joining device according to claim 17, characterised in that the plunger (4) is connected to the transmission unit (2) via a spindle drive (3).

21. A joining device according to claim 20, characterised in that the spindle drive (3) is a circulating ball spindle drive.

22. A joining device according to claim 17, characterised in that the monitoring unit (10) has at least one sensor for detecting process data.

23. A joining device according to claim 22, characterised in that at least one sensor is a displacement transducer which picks up the displacement of the plunger (4) during a joining procedure.

24. A joining device according to claim 22, characterised in that at least one sensor is a force transducer which picks up the force exerted by the plunger during a joining procedure.

25. A joining device according to claim 24, characterised in that the force transducer has at least one piezoelectric element.

26. A joining device according to claim 24, characterised in that the force transducer is a force pickup.

27. A joining device according to claim 24, characterised in that the force transducer is arranged between the plunger (4) and the transmission unit (2).

28. A joining device according to claim 24, characterised in that the transmission unit (2) is supported on a framework and the force transducer is arranged between the transmission unit (2) and the framework.

29. A joining device according to one of claim 22, characterised in that at least one sensor picks up the power consumption of the drive unit (1) during a joining procedure.

30. A joining device according to claim 22, characterised in that at least one sensor measures the torque applied by the drive unit (1) during a joining procedure.

31. A joining device for driving a punch rivet into a work piece, said device comprising a die; a plunger mounted for linear motion to drive a punch rivet into a workpiece supported by said die; and a drive unit coupled to said plunger, said drive unit comprising a source of rotational movement and a transmission for converting rotary motion into linear motion.
